(19) United States
(12) Patent Application Publication
(10) Pub. No.: US 2016/0180122 A1
(43) Pub. Date: Jun. 23, 2016

(54) RADIO FREQUENCY IDENTIFICATION (RFID) BASED DEFECT DETECTION IN SSDS

(71) Applicant: Intel Corporation, Santa Clara, CA (US)

(72) Inventors: ROBERT F. REED, El Dorado Hills, CA (US); KAI-UWE SCHMIDT, Vancouver (CA); CLIFFORD W. JESKE, Vancouver (CA)

(73) Assignee: Intel Corporation, Santa Clara, CA (US)

(21) Appl. No.: 14/574,345

(22) Filed: Dec. 17, 2014

(51) Int. Cl. G06K 7/10

(52) U.S. Cl. CPC G06K 7/10198

(57) ABSTRACT

Methods and apparatus related to authenticating and/or detecting defect(s) in SSDs (or other electronic components) based on information from an RFID (Radio Frequency Identification) tag are described. In one embodiment, non-volatile memory stores one or more parameters corresponding to an electronic component. Logic then reports the one or more parameters to a Radio Frequency Identification (RFID) reader device while the electronic component is powered off or not operational. Other embodiments are also disclosed and claimed.

### FIELD

The present disclosure generally relates to the field of electronics. More particularly, some embodiments generally relate to RFID (Radio Frequency Identification) based defect detection in SSDs (Solid State Drives).

### BACKGROUND

When Solid State Drives (SSDs) are returned to a manufacturer, e.g., due to a defect or for warranty claims, the manufacturer (or re-seller) has to validate the defected SSD to credit the buyer for the defective SSD. To accomplish the validation, sophisticated equipment has to be either at a return distribution center or at the manufacturer or reseller's premises. Also, the SSD has to be powered on and operational to allow for the validation. Furthermore, the personnel required to do this need to be trained to use complex technical equipment.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4-6 illustrate block diagrams of embodiments of computing systems, which may be utilized to implement various embodiments discussed herein.

FIG. 2 illustrates a block diagram of various components of an RFID tag, according to an embodiment.

FIG. 3 illustrates a functional block for an RFID tag, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

To increase performance, some computing systems utilize a Solid State Drive (SSD) that includes non-volatile memory such as flash memory to provide a non-volatile storage solution. Such SSDs generally take less space, weigh less, and are faster than more traditional hard disk drives (HDDs). Furthermore, hard disk drives provide a relatively low-cost storage solution and are used in many computing devices to provide non-volatile storage. Hard disk drives, however, can use a lot of power when compared to Solid State Drives since a hard disk drive needs to spin its rotating disks at a relatively high speed and move disk heads relative to the spinning disks to read/write data. All this physical movement generates heat and increases power consumption. To this end, some mobile devices are migrating towards solid state drives. Also, some non-mobile computing systems (such as desktops, workstations, servers, etc.) may utilize such solid state drives to improve performance.

As discussed above, when Solid State Drives (SSDs) are returned to a manufacturer, e.g., due to a defect or for warranty claims, the manufacturer (or re-seller) has to validate the defected SSD to credit the buyer for the defective SSD. To accomplish the validation, sophisticated equipment has to be either at a return distribution center or at the manufacturer or reseller's premises. Also, the SSD has to be powered on and operational to allow for the validation. Furthermore, the personnel required to do this need to be trained to use complex technical equipment. In one implementation, a visual indicator may be used, but such indicators may be susceptible to drift over temperature and/or time. Further, mechanical/magnetic activated solutions may not meet shock and/or vibration testing requirements associated with an SSD.

To this end, some embodiments provide techniques for authenticating and/or detecting defect(s) in SSDs (e.g., where an SSD can include various components such as NAND and/or NOR memory cells, controller, interface to host, etc.) based on information from an RFID (Radio Frequency Identification) tag. Such embodiments allow for validation or identification of an SSD even when the SSD is not powered on or operational. Hence, some embodiments may be used to more efficiently and/or quickly identify or validate (e.g., defective) products, without the need for powering on the device, having well-trained personal, and/or expensive test equipment.

Furthermore, even though some embodiments are discussed with reference to defect detection and/or authentication of SSDs, embodiments are not limited to SSDs and may be used for other types of non-volatile storage devices such as hard disk drives (e.g., relatively higher failure rates), optical or mechanical storage devices, etc. Moreover, various types of non-volatile memory may be used (e.g., in an SSD or another storage device) including, for example, one or more of: nanowire memory, Ferro-electric transistor random access memory (FeTRAM), magnetoresistive random access memory (MRAM), flash memory, Spin Torque Transfer Random Access Memory (STTRAM), Resistive Random Access Memory, byte addressable 3-Dimensional Cross Point Memory, PCM (Phase Change Memory), etc. Also, some embodiments may be utilized as a “product line feature” by OEM (Original Equipment Manufacturer) to differentiate product lines or used for inventory control and/or reporting.

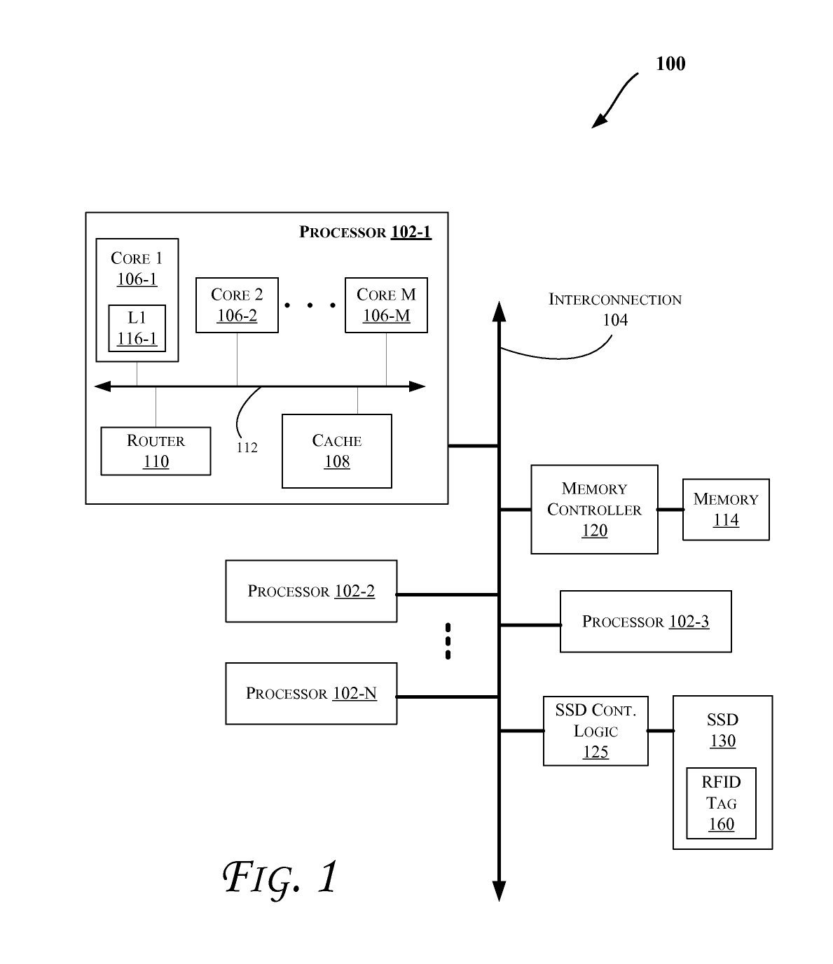

The techniques discussed herein may be provided in various computing systems (e.g., including a non-mobile computing device such as a desktop, workstation, server, rack system, etc. and a mobile computing device such as a smartphone, tablet, UMPC (Ultra-Mobile Personal Computer), laptop computer, Ultrabook™ computing device, smart watch, smart glasses, smart bracelet, etc.), including those discussed with reference to FIGS. 1-6. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

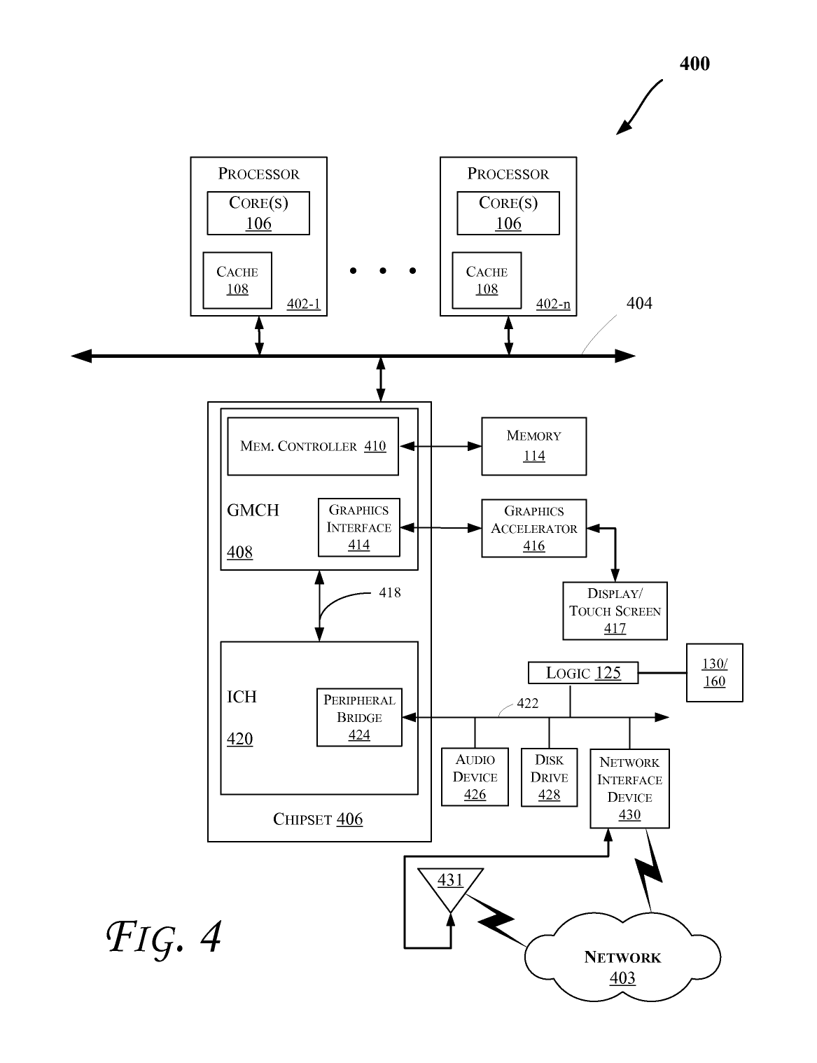

In an embodiment, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 120, memory controllers (such as those discussed with reference to FIGS. 4-6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102. As shown in FIG. 1, the memory 114 may be in communication with the processors 102 via the interconnection 104. In an embodiment, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 1, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

System 100 may also include Non-Volatile (NV) storage device such as an SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 1, logic 125 can alternatively communicate via a storage bus/interconnect (such as the SATA (Serial Advanced Technology Attachment) bus, Peripheral Component Interconnect (PCI) (or PCI express (PCIe) interface), etc.) with one or more other components of system 100 (for example where the storage bus is coupled to interconnect 104 via some other logic like a bus bridge, chipset (such as discussed with reference to FIGS. 4-6), etc.). Additionally, logic 125 may be incorporated into memory controller logic (such as those discussed with reference to FIGS. 1 and 4-6) or provided on a same Integrated Circuit (IC) device in various embodiments (e.g., on the same IC device as the SSD 130 or in the same enclosure as the SSD 130).

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein such as those discussed with reference to other figures including 4-6, for example), including the cores 106, interconnections 104 or 112, components outside of the processor 102, SSD 130, SSD bus, SATA bus, logic 125, RFID tag 160, etc., to sense variations in various factors affecting power/thermal behavior of the system/platform, such as temperature, operating frequency, operating voltage, power consumption, and/or inter-core communication activity, etc.

As illustrated in FIG. 1, SSD 130 may include a RFID tag 160, which may be in the same enclosure as the SSD 130 and/or fully integrated on a Printed Circuit Board (PCB) of the SSD 130. Generally, RFID technology can be utilized for identifying objects via an RFID tag, which functions in response to an RF signal received from a base station or an RFID reader. In turn, the RFID tag reflects an RF signal back to the base station or reader, and information is transferred as the reflected signal is modulated by the RFID tag according to its programmed information protocol.

Chip-based RFID tags include silicon IC chips and antenna/antennae. RFID tags may be passive or active. Passive RFID tags do not use an internal power source, whereas active tags incorporate an internal power source. In an embodiment, the RFID tag 160 is a passive RFID tag. Such passive RFID tags may be powered through RF energy and/or inductively. Moreover, because passive RFID tags do not utilize an onboard power supply (and because they do not require any moving parts), these RFID tags can be very small and may have a nearly unlimited life span. Moreover, passive RFID tags may be read at distances ranging from about 10 cm to a several meters, depending on the chosen radio frequency and antenna design/size, for example. Additionally, such semiconductor based embodiments of the passive RFID tag may be more tolerant to environmental parameters (e.g., within industry expected standards) than other solutions.

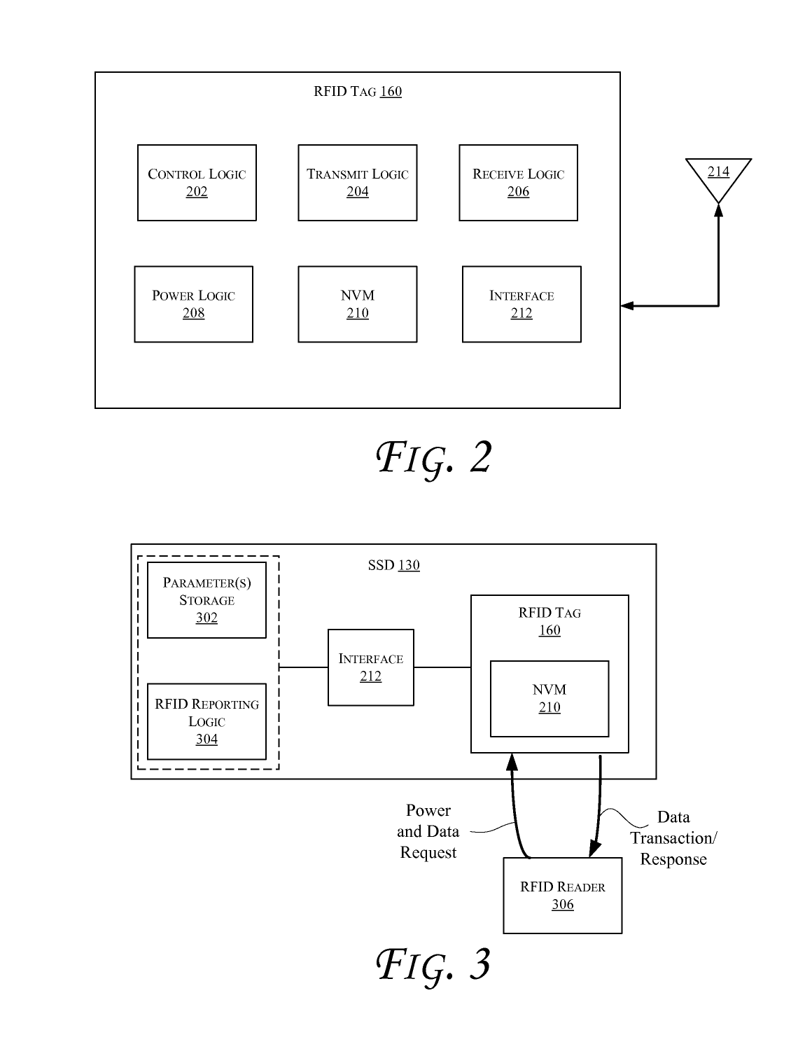

FIG. 2 illustrates a block diagram of various components of an RFID tag, according to an embodiment. The RFID tag of FIG. 2 may be the same as or similar to the RFID tag 160 of FIG. 2. As discussed with reference to FIG. 1, a storage device (such as the SSD 130) or another electronic component may include the RFID tag 160, e.g., to assist in authenticating the component or obtain information regarding the component when the component is not powered.

Referring to FIG. 2, RFID tag 160 includes control logic 202 (e.g., to manage the operations of various components of the RFID tag, where the control logic 202 may include a processor, such as processor 102 of FIG. 1), transmit logic 204 and receive logic 206 (to transmit and/or receive information/signals/data), power logic 208 (e.g., to harvest some of the electrical energy from the received signal and/or to accumulate that electrical energy until it is sufficient to allow the tag 160 to operate), NVM 210 (to store information/data locally within the RFID tag, e.g., as will be further discussed with reference to FIG. 3), an interface 212 (which is an Interface to Communicate (I2C) in an embodiment, although other types of interface(s) may also be used), and an antenna/antennae 214 (e.g., to communicate wireless signal between the RFID tag 160 and other devices such as an RFID reader or base station). In an embodiment, the antenna is located/printed on the PCB of the SSD 130 (e.g., to reduce cost, improve durability and reliability) or may be a mounted component or may be an integral part of the enclosure of the RFID 160. Furthermore, the antenna 214 (or at least a portion of the antenna 214 such as a wire) may transmit through an opening in the enclosure of the RFID 160 (where the enclosure may be shared with the SSD 130 or another electronic component). In an embodiment, the antenna 214 is a UHF antenna (Ultra High Frequency antenna, e.g., operating at about 300 to 3000 MHz with a bandwidth ranging between about 1 m to 10 cm).

In one embodiment, the RFID tag 160 is implemented on a semiconductor chip having RF circuits, various logic circuitry, and memory, as well as one or more antenna/antennae, a collection of discrete components, such as capacitors and diodes, a substrate for mounting the components, interconnections between components, and a physical enclosure (where the enclosure may be shared by the RFID tag chip and another component such as the SSD 130).

As previously mentioned, two types of RFID tags may be used, active tags, which utilize batteries, and passive tags, which are either inductively powered or powered by RF signals used to interrogate the tags (e.g., originating from an RFID reader device). In an embodiment, RFID tag 160 includes at least two parts: an analog logic which detects and decodes/encodes RF signals and provides power to digital logic portion of the tag. These analog and digital logic may be incorporated in various locations within the RFID tag 160, such as control logic 202, transmit logic 204, receive logic 206, power logic 208, and/or I2C interface 212.

FIG. 3 illustrates a functional block for an RFID tag, according to an embodiment. As shown, the SSD 130 may include a programmable set of parameters 302 (e.g., provided via an NVM and programmable, for example, by an Original Equipment Manufacturer (OEM)) and RFID reporting logic 304. The parameter storage 302 and the RFID reporting logic 304 may be part of an (e.g., RFID tag 160) ASIC (Application Specific IC) on the SSD 130 PCB or in the SSD 130 enclosure. Logic 304 and parameters 302 may communicate data (e.g., data that is written to the parameters storage 302 when the SSD 130 is powered on) via the interface 212 to logic within the RFID tag for communication with the RFID reader 306 when the SSD 130 is not operational or powered down. In an embodiment, programmable parameters 302 are stored in the NVM 210. Also, RFID reporting logic 304 may be implemented as part of the control logic 202 of the RFID tag 160.

Referring to FIGS. 2-3, SSD 130 also includes RFID tag 160 which communicates with a base station and/or RFID reader 306 to exchange data requests and data responses/transactions. Also, since RFID tag 160 is a passive RFID tag in an embodiment, the RFID reader 306 may provide a power source (e.g., in the form of RF energy) for the RFID tag 160, as discussed herein.

An embodiment provides a read-able/write-able and parameter programmable passive RFID tag 160 and antennae integrated inside the SSD 130 (e.g., on the motherboard or printed circuit board of the SSD). By contrast, some RIFD tags used in label forms are typically Write Once Read Many (WORM).

In an embodiment, the SSD 130 controls the RFID tag 160 which is programmed and configured when the SSD is powered on. The SSD 130 may make available key parameters and SMART (Self-Monitoring, Analysis and Reporting Technology) and/or other attributes that contain OEM programmable selection(s) through the RFID tag 160. The RFID tag 160 may report out parameters (e.g., by RFID reporting logic 304) including for example: part number, critical errors, end of life indicators (such as E9 or E8), etc. (e.g., stored in the programmable parameters storage 302). “E8” generally refers to an attribute that reports the number of reserve blocks remaining. The normalized value generally begins at 100, which corresponds to 100 percent availability of the reserved space and the threshold value for this attribute may be about 10 percent availability. “E9” generally refers to an attribute that reports the number of cycles the NAND media has undergone. The normalized value generally declines linearly from 100 to 1 as the average erase cycle count increases from 0 to the maximum rated cycles. Once the normalized value reaches 1, the number will not decrease, although it is likely that significant additional wear can be put on the device.

Furthermore, the RFID tag may be written to and updated on a regular or periodic basis while the SSD 130 is working and has power. When the drive is powered down, the last known state of the parameters as tracked by logic (e.g., within SSD 130 such as reporting logic 304) is written to the RFID tag 160 NVM 210. For example, when the SSD 130 is returned to a manufacturer or sales channel partner, the SSD status can be read with no special equipment configuration (i.e., the returned SSD (or HDD (Hard Disk Drive)) with the RFID tag 160 does not need to be a pluggable system, or running systems software).

Additionally, having some embodiments integrated into the SSD 130, an OEM or entity responsible for paying for warranty can easily and quickly read the status of the SSD 130 and determine whether the SSD is defective or meets warranty entitlement. Furthermore, using some embodiments, no power is needed to be applied to the SSD 130, which reduces complexity in training employees and test equipment costs, e.g., since a simple RFID handheld reader can be used (e.g., plugged into a standard PC environment) with no specialist chassis or dedicated test equipment or personnel. Accordingly, some embodiments provide an easy mechanism to read the condition of an SSD with no computer equipment needed or a powered SSD to detect the condition of the SSD.

FIG. 4 illustrates a block diagram of a computing system 400 in accordance with an embodiment. The computing system 400 may include one or more central processing unit(s) (CPUs) 402 or processors that communicate via an interconnection network (or bus) 404. The processors 402 may include a general purpose processor, a network processor (that processes data communicated over a computer network 403), an application processor (such as those used in cell phones, smart phones, etc.), or other types of a processor (including a reduced instruction set computer (RISC) processor or a complex instruction set computer (CISC)). Various types of computer networks 403 may be utilized including wired (e.g., Ethernet, Gigabit, Fiber, etc.) or wireless networks (such as cellular, 3G (Third-Generation Cell-Phone Technology or 3rd Generation Wireless Format (UWCC)), 4G, Low Power Embedded (LPE), etc.). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

In an embodiment, one or more of the processors 402 may be the same or similar to the processors 102 of FIG. 1. For example, one or more of the processors 402 may include one or more of the cores 106 and/or cache 108. Also, the operations discussed with reference to FIGS. 1-3 may be performed by one or more components of the system 400.

A chipset 406 may also communicate with the interconnection network 404. The chipset 406 may include a graphics and memory control hub (GMCH) 408. The GMCH 408 may include a memory controller 410 (which may be the same or similar to the memory controller 120 of FIG. 1 in an embodiment) that communicates with the memory 114. The memory 114 may store data, including sequences of instructions that are executed by the CPU 402, or any other device included in the computing system 400. Also, system 400 includes logic 125 and SSD 130 with RFID tag 160 (which may be coupled to system 400 via bus 422 as illustrated, via other interconnects such as 404, where logic 125 is incorporated into chipset 406, etc. in various embodiments). In one embodiment, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk drive, flash, etc., including any NVM discussed herein. Additional devices may communicate via the interconnection network 404, such as multiple CPUs and/or multiple system memories.

The GMCH 408 may also include a graphics interface 414 that communicates with a graphics accelerator 416. In one embodiment, the graphics interface 414 may communicate with the graphics accelerator 416 via an accelerated graphics port (AGP) or Peripheral Component Interconnect (PCI) (or PCI express (PCIe) interface). In an embodiment, a display 417 (such as a flat panel display, touch screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display 417.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403, e.g., via a wired or wireless interface). As shown, the network interface device 430 may be coupled to an antenna 431 to wirelessly (e.g., via an Institute of Electrical and Electronics Engineers (IEEE) 802.11 interface (including IEEE 802.11a/b/g/n, etc.), cellular interface, 3G, 4G, LPE, etc.) communicate with the network 403. Other devices may communicate via the bus 422. Also, various components (such as the network interface device 430) may communicate with the GMCH 408 in some embodiments. In addition, the processor 402 and the GMCH 408 may be combined to form a single chip. Furthermore, the graphics accelerator 416 may be included within the GMCH 408 in other embodiments.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

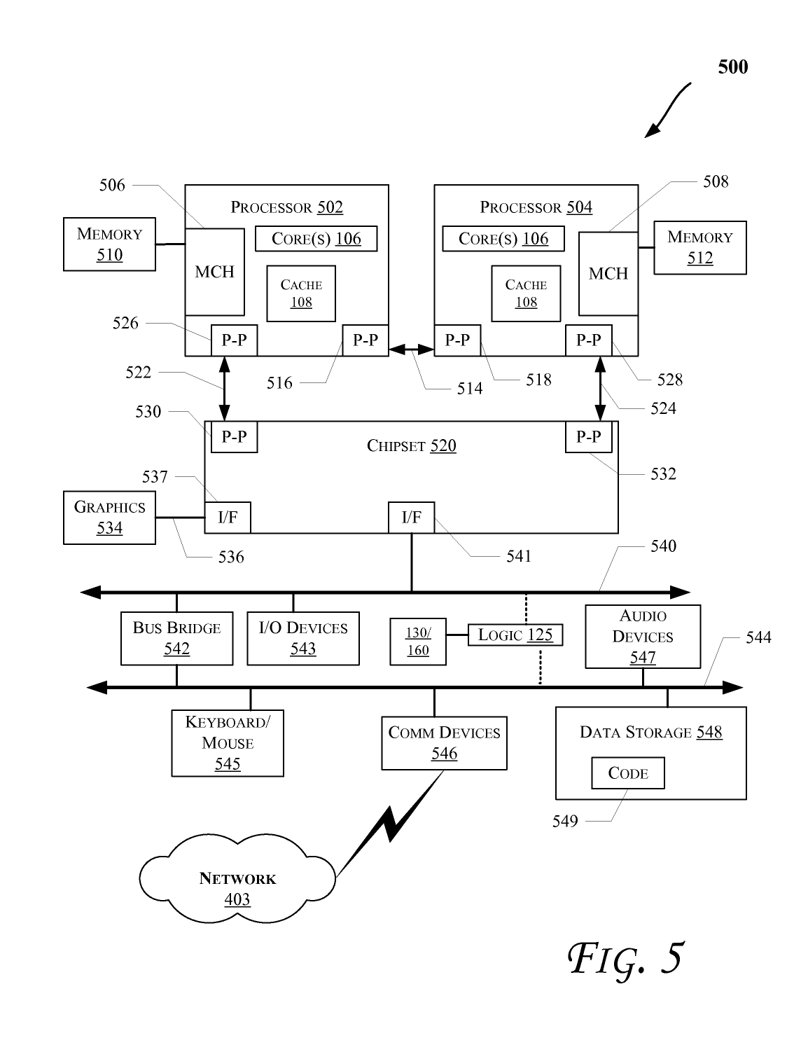

FIG. 5 illustrates a computing system 500 that is arranged in a point-to-point (PtP) configuration, according to an embodiment. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 114 of FIGS. 1 and/or 4. Also, MCH 506 and 508 may include the memory controller 120 in some embodiments. Furthermore, system 500 includes logic 125 and SSD 130 with RFID tag 160 (which may be coupled to system 500 via bus 540/644 such as illustrated, via other point-to-point connections to the processor(s) 502/604 or chipset 520, where logic 125 is incorporated into chipset 520, etc. in various embodiments).

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537. As discussed with reference to FIG. 4, the graphics interface 536 may be coupled to a display device (e.g., display 417) in some embodiments.

As shown in FIG. 5, one or more of the cores 106 and/or cache 108 of FIG. 1 may be located within the processors 502 and 504. Other embodiments, however, may exist in other circuits, logic units, or devices within the system 500 of FIG. 5. Furthermore, other embodiments may be distributed throughout several circuits, logic units, or devices illustrated in FIG. 5.

The chipset 520 may communicate with a bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403, as discussed with reference to network interface device 430 for example, including via antenna 431), audio I/O device, and/or a data storage device 548. The data storage device 548 may store code 549 that may be executed by the processors 502 and/or 504.

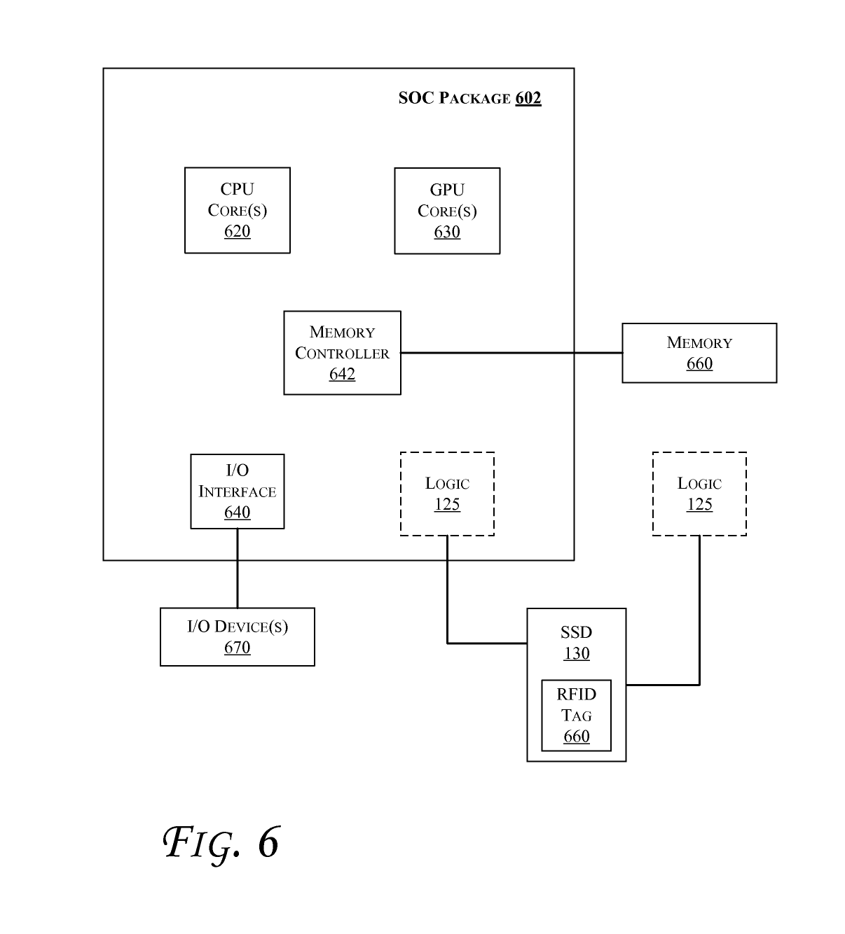

In some embodiments, one or more of the components discussed herein can be embodied as a System On Chip (SOC) device. FIG. 6 illustrates a block diagram of an SOC package in accordance with an embodiment. As illustrated in FIG. 6, SOC 602 includes one or more Central Processing Unit (CPU) cores 620, one or more Graphics Processor Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 620 may include one or more other components, e.g., as discussed with reference to the other figures herein. In one embodiment, SOC package 602 (and its components) is provided on one or more Integrated Circuit (IC) die, e.g., which are packaged onto a single semiconductor device.

As illustrated in FIG. 6, SOC package 602 is coupled to a memory 660 (which may be similar to or the same as memory discussed herein with reference to the other figures) via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display, an image/video capture device (such as a camera or camcorder/video recorder), a touch screen, a speaker, or the like. Furthermore, SOC package 602 may include/integrate the logic 125 in an embodiment. Alternatively, the logic 125 may be provided outside of the SOC package 602 (i.e., as a discrete logic).

The following examples pertain to further embodiments. Example 1 includes An apparatus comprising: non-volatile memory to store one or more parameters corresponding to an electronic component; logic to report the one or more parameters to a Radio Frequency Identification (RFID) reader device while the electronic component is powered off or not operational. Example 2 includes the apparatus of example 1, wherein an RFID tag coupled to the electronic component is to comprise the non-volatile memory and the logic. Example 3 includes the apparatus of example 1, wherein a passive RFID tag coupled to the electronic component is to comprise the non-volatile memory and the logic, wherein the passive RFID tag is to operate in response to Radio Frequency (RF) energy originating from the RFID reader device. Example 4 includes the apparatus of example 1, comprising logic to write the one or more parameters to the non-volatile memory when the electronic component is powered and operational. Example 5 includes the apparatus of example 1, wherein an RFID tag coupled to the electronic component is to comprise the non-volatile memory and the logic and wherein a Solid State Drive (SSD) is to comprise the RFID tag. Example 6 includes the apparatus of example 1, wherein the one or more parameters are to comprise one or more of: a part number, one or more critical errors, and one or more of end of life indicators. Example 7 includes the apparatus of example 1, wherein the non-volatile memory, the logic, and a Solid State Drive (SSD) are on a same integrated circuit device. Example 8 includes the apparatus of example 1, wherein the electronic component is to comprise non-volatile memory. Example 9 includes the apparatus of example 8, wherein the non-volatile memory is to comprise one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), and byte addressable 3-Dimensional Cross Point Memory. Example 10 includes the apparatus of example 1, wherein an SSD is to comprise the non-volatile memory and the logic.

Example 11 includes a method comprising: storing one or more parameters corresponding to an electronic component in non-volatile memory; reporting the one or more parameters to a Radio Frequency Identification (RFID) reader device while the electronic component is powered off or not operational. Example 12 includes the method of example 11, further comprising a passive RFID tag operating in response to Radio Frequency (RF) energy originating from the RFID reader device. Example 13 includes the method of example 11, further comprising writing the one or more parameters to the non-volatile memory when the electronic component is powered and operational. Example 14 includes the method of example 11, wherein the one or more parameters comprise one or more of: a part number, one or more critical errors, and one or more of end of life indicators. Example 15 includes the method of example 11, wherein the electronic component comprises one of: a Solid State Drive (SSD), a hard disk drive, optical or mechanical storage device, nanowire memory, Ferro-electric transistor random access memory (FeTRAM), magnetoresistive random access memory (MRAM), flash memory, Spin Torque Transfer Random Access Memory (STTRAM), Resistive Random Access Memory, PCM, and byte addressable 3-Dimensional Cross Point Memory.

Example 16 includes a system comprising: non-volatile memory; and at least one processor core to access the non-volatile memory; the non-volatile memory to store one or more parameters corresponding to an electronic component; logic to report the one or more parameters to a Radio Frequency Identification (RFID) reader device while the electronic component is powered off or not operational. Example 17 includes the system of example 16, wherein an RFID tag coupled to the electronic component is to comprise the non-volatile memory and the logic. Example 18 includes the system of example 16, wherein a passive RFID tag coupled to the electronic component is to comprise the non-volatile memory and the logic, wherein the passive RFID tag is to operate in response to Radio Frequency (RF) energy originating from the RFID reader device. Example 19 includes the system of example 16, comprising logic to write the one or more parameters to the non-volatile memory when the electronic component is powered and operational. Example 20 includes the system of example 16, wherein an RFID tag coupled to the electronic component is to comprise the non-volatile memory and the logic and wherein a Solid State Drive (SSD) is to comprise the RFID tag. Example 21 includes the system of example 16, wherein the one or more parameters are to comprise one or more of: a part number, one or more critical errors, and one or more of end of life indicators. Example 22 includes the system of example 16, wherein the non-volatile memory, the logic, and an SSD are on a same integrated circuit device. Example 23 includes the system of example 16, wherein the electronic component is to comprise one of: a Solid State Drive (SSD), a hard disk drive, optical or mechanical storage device, nanowire memory, Ferro-electric transistor random access memory (FeTRAM), magnetoresistive random access memory (MRAM), flash memory, Spin Torque Transfer Random Access Memory (STTRAM), Resistive Random Access Memory, PCM, and byte addressable 3-Dimensional Cross Point Memory. Example 24 includes the system of example 16, wherein an SSD is to comprise the non-volatile memory and the logic.

Example 25 includes an apparatus comprising means to perform a method as set forth in any preceding example.

Example 26 comprises machine-readable storage including machine-readable instructions, when executed, to implement a method or realize an apparatus as set forth in any preceding example.

In various embodiments, the operations discussed herein, e.g., with reference to FIGS. 1-6, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
non-volatile memory to store one or more parameters corresponding to an electronic component;
logic to report the one or more parameters to a Radio Frequency Identification (RFID) reader device while the electronic component is powered off or not operational.

2. The apparatus of claim 1, wherein an RFID tag coupled to the electronic component is to comprise the non-volatile memory and the logic.

3. The apparatus of claim 1, wherein a passive RFID tag coupled to the electronic component is to comprise the non-volatile memory and the logic, wherein the passive RFID tag is to operate in response to Radio Frequency (RF) energy originating from the RFID reader device.

4. The apparatus of claim 1, comprising logic to write the one or more parameters to the non-volatile memory when the electronic component is powered and operational.

5. The apparatus of claim 1, wherein an RFID tag coupled to the electronic component is to comprise the non-volatile memory and the logic and wherein a Solid State Drive (SSD) is to comprise the RFID tag.

6. The apparatus of claim 1, wherein the one or more parameters are to comprise one or more of: a part number, one or more critical errors, and one or more of end of life indicators.

7. The apparatus of claim 1, wherein the non-volatile memory, the logic, and a Solid State Drive (SSD) are on a same integrated circuit device.

8. The apparatus of claim 1, wherein the electronic component is to comprise non-volatile memory.

9. The apparatus of claim 8, wherein the non-volatile memory is to comprise one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), and byte addressable 3-Dimensional Cross Point Memory.

10. The apparatus of claim 1, wherein an SSD is to comprise the non-volatile memory and the logic.

11. A method comprising:
storing one or more parameters corresponding to an electronic component in non-volatile memory;
reporting the one or more parameters to a Radio Frequency Identification (RFID) reader device while the electronic component is powered off or not operational.

12. The method of claim 11, further comprising a passive RFID tag operating in response to Radio Frequency (RF) energy originating from the RFID reader device.

13. The method of claim 11, further comprising writing the one or more parameters to the non-volatile memory when the electronic component is powered and operational.

14. The method of claim 11, wherein the one or more parameters comprise one or more of: a part number, one or more critical errors, and one or more of end of life indicators.

15. The method of claim 11, wherein the electronic component comprises one of: a Solid State Drive (SSD), a hard disk drive, optical or mechanical storage device, nanowire memory, Ferro-electric transistor random access memory (FeTRAM), magnetoresistive random access memory (MRAM), flash memory, Spin Torque Transfer Random Access Memory (STTRAM), Resistive Random Access Memory, PCM, and byte addressable 3-Dimensional Cross Point Memory.

16. A system comprising:
non-volatile memory; and
at least one processor core to access the non-volatile memory;
the non-volatile memory to store one or more parameters corresponding to an electronic component;
logic to report the one or more parameters to a Radio Frequency Identification (RFID) reader device while the electronic component is powered off or not operational.

17. The system of claim 16, wherein an RFID tag coupled to the electronic component is to comprise the non-volatile memory and the logic.

18. The system of claim 16, wherein a passive RFID tag coupled to the electronic component is to comprise the non-volatile memory and the logic, wherein the passive RFID tag is to operate in response to Radio Frequency (RF) energy originating from the RFID reader device.

19. The system of claim 16, comprising logic to write the one or more parameters to the non-volatile memory when the electronic component is powered and operational.

20. The system of claim 16, wherein an RFID tag coupled to the electronic component is to comprise the non-volatile memory and the logic and wherein a Solid State Drive (SSD) is to comprise the RFID tag.

21. The system of claim 16, wherein the one or more parameters are to comprise one or more of: a part number, one or more critical errors, and one or more of end of life indicators.

22. The system of claim 16, wherein the non-volatile memory, the logic, and an SSD are on a same integrated circuit device.

23. The system of claim 16, wherein the electronic component is to comprise one of: a Solid State Drive (SSD), a hard disk drive, optical or mechanical storage device, nanowire memory, Ferro-electric transistor random access memory (FeTRAM), magnetoresistive random access memory (MRAM), flash memory, Spin Torque Transfer Random Access Memory (STTRAM), Resistive Random Access Memory, PCM, and byte addressable 3-Dimensional Cross Point Memory.

24. The system of claim 16, wherein an SSD is to comprise the non-volatile memory and the logic.
